(19) United States
(12) Patent Application Publication
(10) Pub. No.: US 2013/0087555 A1
(43) Pub. Date: Apr. 11, 2013

(54) MICROWAVE OVEN

(71) Applicants: Seiichi Hirano, Osaka-Shi (JP); Seiji Kanbara, Osaka-Shi (JP)

(72) Inventors: Seiichi Hirano, Osaka-Shi (JP); Seiji Kanbara, Osaka-Shi (JP)

(73) Assignee: SHARP KABUSHIKI KAISHA, Osaka-Shi, Osaka (JP)

(21) Appl. No.: 13/703,700

(22) PCT Filed: Jul. 7, 2011
(86) PCT No.: PCT/JP2011/065532

§ 371 Date: Dec. 12, 2012

(30) Foreign Application Priority Data
Jul. 9, 2010 (JP) 2010-156504

(51) Int. Cl. H05B 6/68

(52) U.S. Cl. CPC H05B 6/687
USPC 219/720

(57) ABSTRACT

Disclosed is a microwave oven provided with: a heating chamber (2) for housing the object to be cooked therein; a magnetron (7) that oscillates by having a voltage applied thereto, and generates a microwave to be supplied to the heating chamber (2); a radio wave sensor (11) for detecting the microwave generated by the magnetron (7); a timer (15) for measuring an oscillation starting time that is a period of time from when the voltage is applied to the magnetron (7) to when the microwave is detected by the radio wave sensor (11) due to the oscillation; and a notification unit (6) for sending a notice about the timing at which the magnetron (7) should be exchanged. When the oscillation starting time becomes longer than a prescribed period of time, a notice about that fact is sent by the notification unit (6).

### TECHNICAL FIELD

The present invention relates to a microwave oven provided with a magnetron.

### BACKGROUND ART

A conventional microwave oven is disclosed in Patent Literature 1. This microwave oven is provided with a heating chamber in which a cooking object is placed, and the microwave oven incorporates a magnetron which oscillates in response to application of voltage, to thereby generate a microwave. The microwave generated by the magnetron is supplied into a heating chamber, where a cooking operation is performed with respect to the cooking object.

In addition, the microwave oven is provided with a timer which counts driving time of the magnetron. The driving time of the magnetron counted by the timer is stored in an accumulated manner as cumulative driving time. When the cumulative driving time of the magnetron exceeds a predetermined length of replacement time, it is judged that the life of the magnetron is close to its end, and a notice is given to the effect that it is time to replace the magnetron through a display portion or the like.

This notice enables a user to replace the magnetron before its life expires and the magnetron stops working. Thus, it is possible to prevent failure of cooking caused by the magnetron stopping in the middle of a cooking operation. Furthermore, in the case of a business-use microwave oven, the magnetron can be replaced out of business hours, and this helps avoid downtime of the microwave oven, to thereby prevent reduction of the operating ratio of the microwave oven.

### CITATION LIST

### Patent Literature

Patent Literature 1: JP-A H02-233909 (Pages 1-4, FIG. 1)

### SUMMARY OF INVENTION

### Technical Problem

However, according to the above conventional microwave oven, different magnetrons have different lengths of lives due to individual difference. FIG. 7 shows statistical data of lives of magnetrons. The ordinate indicates the cumulative failure rate F(t) (unit: %), and the abscissa indicates the cumulative driving time (unit: h). The cumulative failure rate (fault rate) indicates the relationship between the cumulative driving time of magnetrons and the percentage of magnetrons failed in the cumulative driving time.

Based on such statistical data as shown in FIG. 7, magnetron replacement time is set to a length of time (such as 1000 hours) at the end of which, for example, 1% of magnetrons failed and their lives expired. As a result, a large number of magnetrons that are not as much degraded as have to be replaced are also replaced, too early, before their lives actually come to an end. This has led to the problem of high running cost of microwave ovens attributable to the too frequent replacement of magnetrons.

The present invention has been made to provide a microwave oven capable of reducing running cost.

### Solution to Problem

To achieve the above object, according to the present invention, a microwave over includes a heating chamber in which a cooking object is to be placed, a magnetron which oscillates in response to application of voltage thereto to thereby generate a microwave to be supplied into the heating chamber, an electric wave sensor which detects the microwave generated by the magnetron, a timer which counts oscillation start-up time of the magnetron, the oscillation start-up time starting when the voltage is applied to the magnetron and ending when the microwave generated by oscillation of the magnetron is detected by the electric wave sensor, and a notification portion which makes a notification concerning time to replace the magnetron. Here, the notification portion makes the notification when the oscillation start-up time exceeds a predetermined length of time.

With this configuration, when a voltage is applied to the magnetron, the timer starts counting time. When the magnetron oscillates in response to the application of the voltage, a microwave is generated. When the electric wave sensor detects the microwave, the timer counts oscillation start-up time which starts at the application of the voltage to the magnetron and ends at the start of the oscillation. The microwave generated by the magnetron is supplied into the heating chamber, where a cooking operation is performed on the cooking object. When the oscillation start-up time exceeds the predetermined length of time, the notification portion notifies that it is time to replace the magnetron.

According to a preferable embodiment of the present invention, it is preferable that the oscillation start-up time be stored, and that the notification portion make the notification if the oscillation start-up time exceeds the predetermined length of time a plurality of times in a row.

According to a preferable embodiment of the present invention, it is preferable that a plurality of magnetrons be provided as the magnetron, and that the magnetrons each oscillate in different phases. With this configuration, the plurality of magnetrons oscillate in different phases, and the electric wave sensor detects microwaves from the plurality of magnetrons one by one at different time points.

According to a preferable embodiment of the present invention, it is preferable that the timer count driving time of the magnetron, that the oscillation start-up time and cumulative driving time of the magnetron be stored, and that the oscillation start-up time and the cumulative driving time of the magnetron be readable.

With this configuration, when the magnetron is driven and a cooking operation is performed, the timer counts the driving time. The driving time of the magnetron is stored as cumulative driving time, and the oscillation start-up time from the voltage application to the start of oscillation is also stored. An operator is able to read and acquire the cumulative driving time and the oscillation start-up time by a predetermined operation. This makes it possible to estimate, based on statistical data acquired in advance, how much driving time of the magnetron is left before it needs to be replaced.

### Advantageous Effects of Invention

According to the present invention, an electric wave sensor is provided to detect a microwave, and time to replace the magnetron is notified when oscillation start-up time between the application of a voltage to the magnetron and the detection of the microwave by the electric wave sensor exceeds a predetermined length of time. This makes it possible to keep using the magnetron until the oscillation start-up time becomes longer due to degradation. Thus, it is possible to replace the magnetron less frequently, to thereby reduce the running cost of the microwave oven.

### BRIEF DESCRIPTION OF DRAWINGS

FIG. 1 is a perspective view showing a microwave oven embodying the present invention;

FIG. 2 is a front sectional view showing an interior of the microwave oven embodying the present invention;

FIG. 3 is a side sectional view showing an electric wave sensor incorporated in the microwave oven embodying the present invention;

FIG. 4 is a block diagram showing a configuration of the microwave oven embodying the present invention;

FIG. 5 is a flow chart showing an operation of the microwave oven embodying the present invention;

FIG. 6 is a diagram showing relationship between the cumulative driving time and the oscillation start-up time of a magnetron; and

FIG. 7 is a diagram showing statistical data of the life of magnetrons.

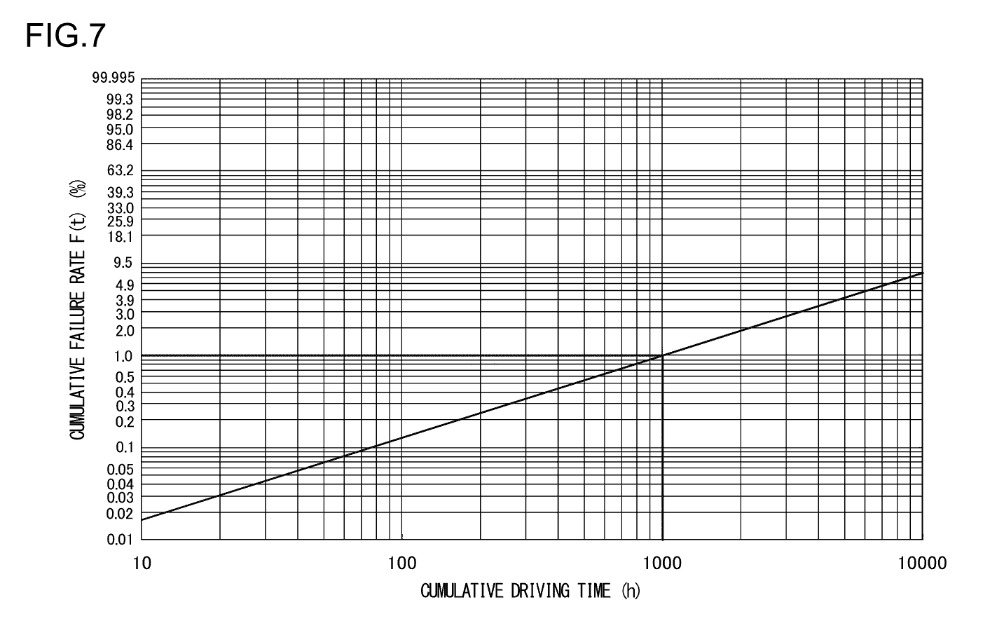

### DESCRIPTION OF EMBODIMENTS

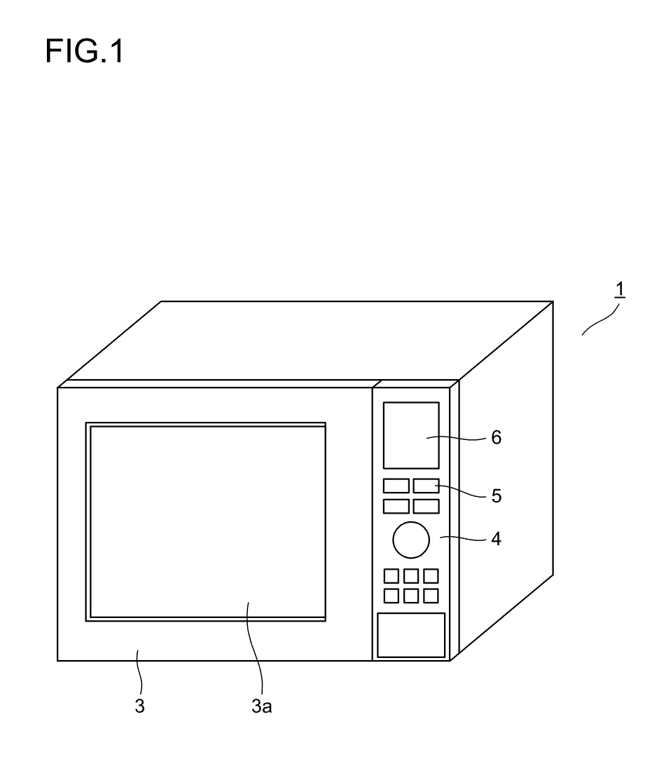

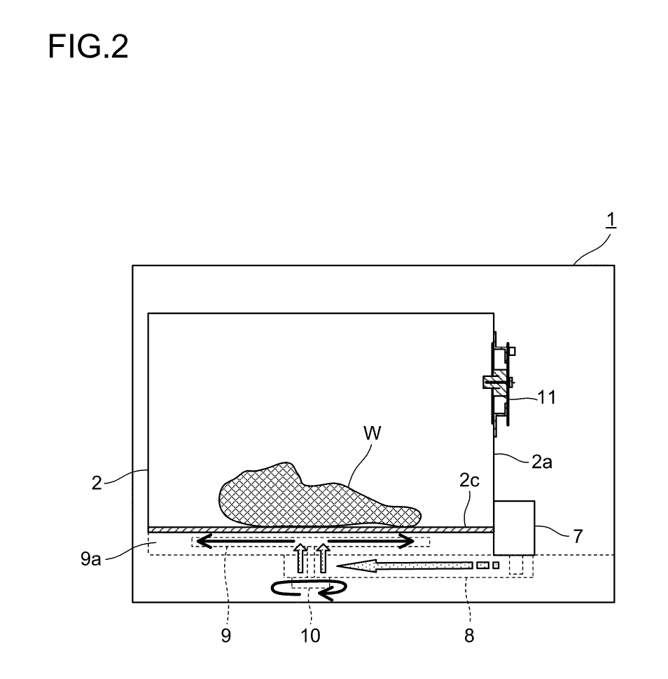

Hereinafter, embodiments of the present invention will be described with reference to the accompanying drawings. FIG. 1 is a perspective view showing a microwave oven embodying the present invention. A door 3 is disposed at the front face of a microwave oven 1 for opening and closing a heating chamber 2 (see FIG. 2). In the door 3, a window portion 3a is formed through which to visually check the heating chamber 2. An operation panel 4 is disposed lateral to the door 3. In the operation panel 4, there are provided an operation portion 5 and a display portion 6.

The operation portion 5 has a plurality of keys and a touch panel provided on the display portion 6, on which an operation of selecting a cooking menu is performed, and through which an instruction is given to start a cooking operation. The display portion 6 is formed of components such as a liquid crystal panel, and displays an operation screen showing the operation performed on the operation portion 5, the progress of the cooking operation, and the like. Besides, the display portion 6 also functions as a notification portion which makes a notification to a user by displaying a message or the like for the user to see.

FIG. 2 is a front sectional view showing an interior of the microwave oven 1. A cooking object W is placed on a bottom plate 2c of the heating chamber 2 which is open at the front. A plurality of magnetrons 7 are disposed lateral to the heating chamber 2 and generate microwaves by oscillating when voltage is applied thereto. The magnetrons 7 and the heating chamber 2 are coupled to each other by a waveguide tube 8. The microwaves generated by the magnetrons 7 are guided through the waveguide tube 8 and supplied into the heating chamber 2. An antenna chamber 9a is provided under the bottom plate 2c, and in the antenna chamber 9a, there is provided an antenna 9 which rotates by being driven by the antenna motor 10. The microwaves supplied into the heating chamber 2 are made uniform by the rotation of the antenna 9.

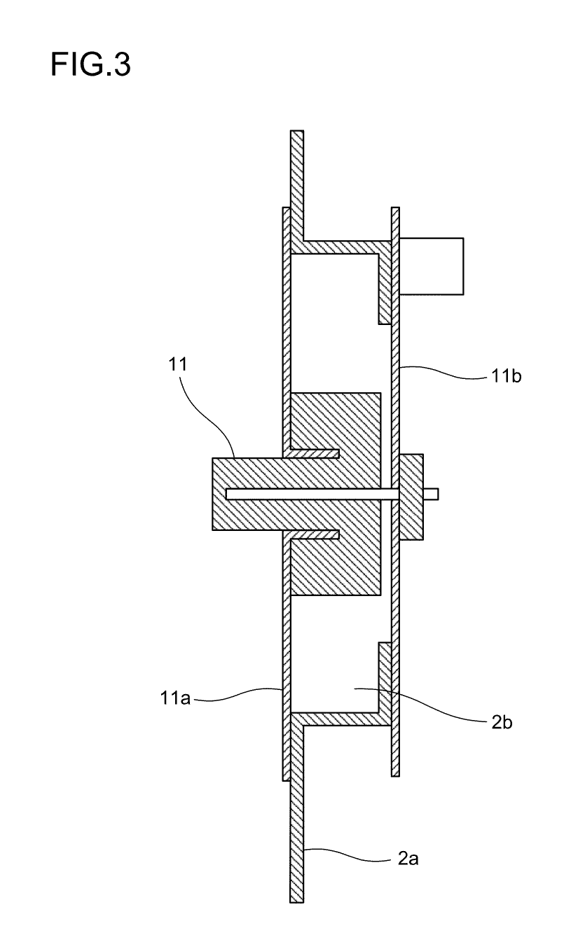

On a side wall 2a of the heating chamber 2, there is provided an electric wave sensor 11 which detects a microwave. FIG. 3 is a side sectional view of the electric wave sensor 11. The electric wave sensor 11 has a front plate 11a and a rear plate 11b, and is disposed in a recess 2b which is provided in the side wall 2a of the heating chamber 2. The rear plate 11b is attached to a bottom surface of the recess 2b, with the recess 2b covered by the front plate 11a, and with the electric wave sensor 11 projecting into the heating chamber 2 from the front plate 11a.

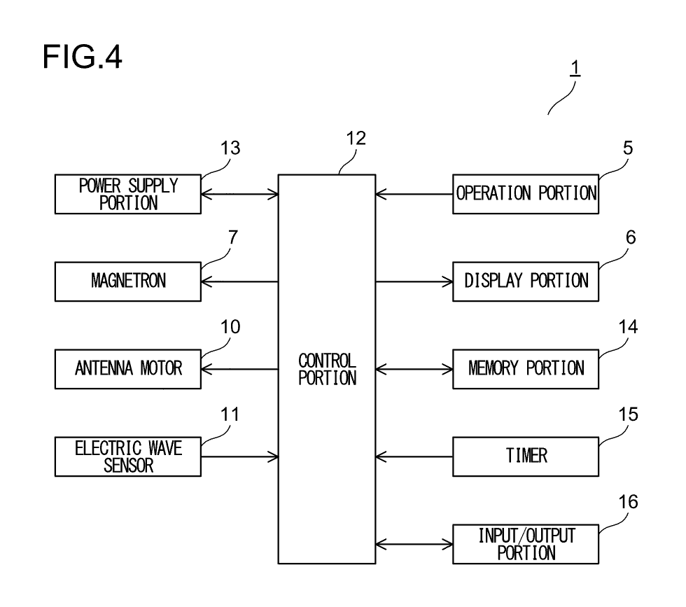

FIG. 4 is a block diagram showing an example of the configuration of the microwave oven 1. In the microwave oven 1, a control portion 12 which controls each portion is provided on a rear side of the operation panel 4 (see FIG. 1). A power supply portion 13, the magnetrons 7, the antenna motor 10, the electric wave sensor 11, the operation portion 5, the display portion 6, a memory portion 14, a timer 15, and an input/output portion 16 are connected to the control portion 12.

The power supply portion 13 supplies power to the control portion 12, and it also supplies power to each portion of the microwave oven 1 under the control of the control portion 12. The memory portion 14, which is composed of an RAM and an ROM, stores a sequence of cooking performed by the microwave oven 1, and it also stores a cooking menu database. Furthermore, the memory portion 14 temporarily stores results of computation performed by the control portion 12, and the memory portion 14 also stores data obtained by the electric wave sensor 11 and the like.

The timer 15 counts driving time of the magnetrons 7, cooking time, and the like. The input/output portion 16 is capable of being connected to an external device to update and read out the sequence of cooking stored in the memory portion 14.

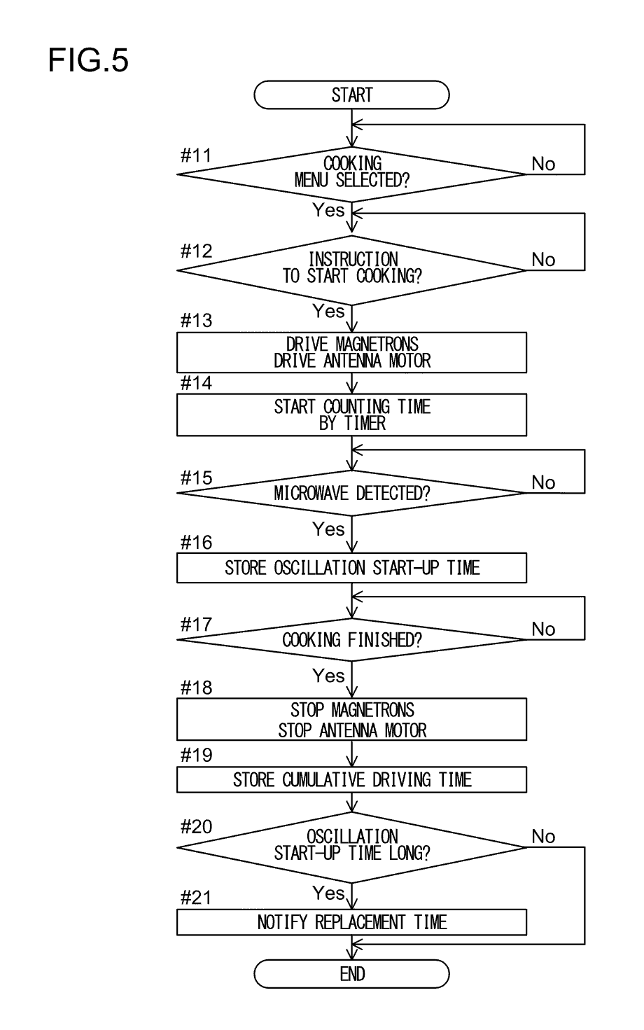

FIG. 5 is a flow chart showing an operation of the microwave oven 1. When the microwave oven 1 is turned on, the process waits until a cooking menu is selected by the operation portion 5 in step #11. When a cooking object W is placed inside the heating chamber 2 and a cooking menu is selected, the process waits until an instruction is given by the operation portion 5 in step #12 to start cooking.

When the instruction to start cooking is received, a voltage from the power supply 13 is applied to the magnetrons 7 and the antenna motor 10 under the control of the control portion 12, and thereby the magnetrons 7 and the antenna motor 10 are driven in step #13. Here, the plurality of magnetrons 7 are driven in different phases. In step #14, the timer 15 starts counting time.

In step #15, the process waits until the electric wave sensor 11 detects a microwave. Here, since the plurality of magnetrons are driven in different phases, the electric wave sensor 11 detects the microwaves from the magnetrons 7 at different times. This makes it possible to identify the source magnetron 7 of each of the microwaves detected by the electric wave sensor 11.

When the electric wave sensor 11 detects the microwaves each generated by oscillation of a corresponding one of the magnetrons 7, the process proceeds to step #16. In step #16, oscillation start-up time, which is counted by the timer 15 from the voltage application until the detection of the microwaves by the electric wave sensor 11, is stored in the memory portion one by one corresponding to each of the magnetrons 7.

In step #17, the timer 15 continues time counting until the time to finish cooking comes. When the time to finish cooking comes, then in step #18, the magnetrons 7 and the antenna motor 10 are made to stop operating. In step #19, cumulative driving time, which is obtained by accumulating the driving time of the magnetrons 7 counted by the timer 15, is stored in the memory portion 14. That is, the driving time of the cooking operation this time is added to the cumulative driving time stored at the end of the previous cooking operation, and the resulting cumulative driving time is stored in the memory portion 14.

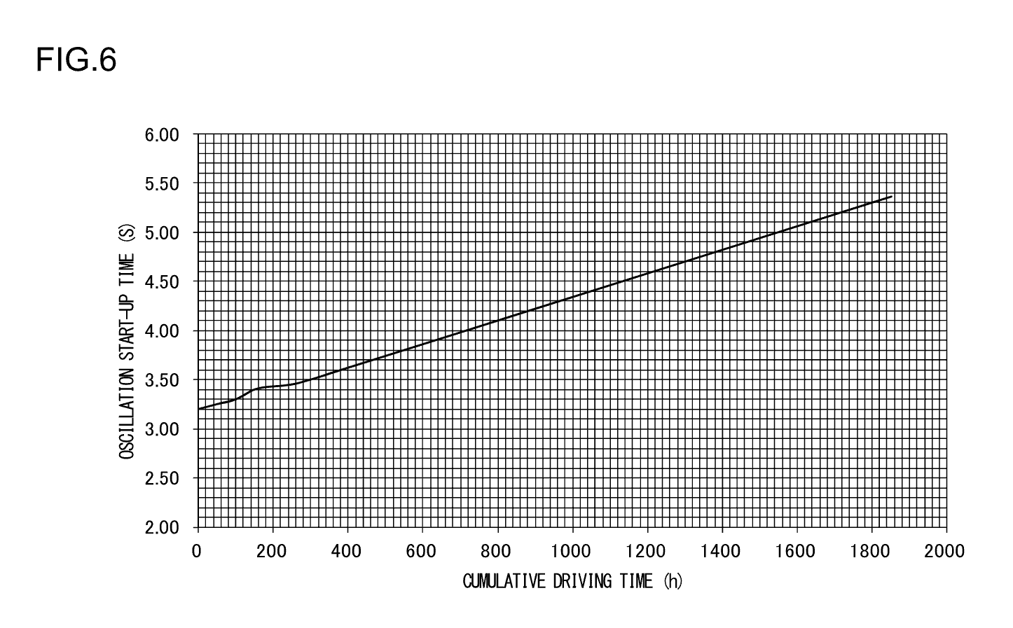

In step #20, it is judged whether or not the oscillation start-up time of each of the magnetrons 7 stored in step #16 is longer than a predetermined length of time. FIG. 6 is a diagram showing an example of the relationship between the cumulative driving time and the oscillation start-up time of a magnetron. The ordinate indicates the oscillation start-up time (unit: second), and the abscissa indicates the cumulative driving time (unit: hour).

According to the figure, the oscillation start time, which is time from when a voltage is applied to the magnetrons until when the magnetrons start oscillating, increases substantially linearly as the magnetrons are increasingly degraded with accumulation of driving. Thus, statistical data is acquired in advance as to lengths of the oscillation start-up time of the magnetrons 7 at the end of their lives, and when the oscillation start-up time becomes as long as a predetermined length of time (for example, 4.5 seconds) that is shorter than the oscillation time that the magnetrons 7 have at the end of their lives, it is judged to be the time to replace the magnetrons 7. It should be noted that the figure merely shows an example, and the oscillation start-up time of different magnetrons increases at different rates with respect to the cumulative driving time due to individual difference.

If the oscillation start-up time of each of the magnetrons 7 is not longer than the predetermined length of time, the process is finished. If the oscillation start-up time of any of the magnetrons 7 is longer than the predetermined length of time, the process proceeds to step #21. In step #21, a message or a warning icon, for example, is displayed on the display portion 6 to thereby notify the user that it is time to replace a magnetron 7. This enables the user to replace any of the magnetrons 7, which have different lengths of lives, when it is degraded enough to be replaced. Incidentally, lighting of a warning light or sound may be used to notify the time to replace any of the magnetrons 7.

Furthermore, the oscillation start-up time and the cumulative driving time of each of the magnetrons 7 stored in the memory portion 14 are read out via the input/output portion 16 by an operator such as a maintenance person. As to the relationship between the oscillation start-up time and the cumulative driving time, the statistical data as shown in the above-mentioned FIG. 6 is acquired in advance. By comparing the data read out from the memory portion 14 and the statistical data, it is possible to estimate the length of drivable time of the magnetrons 7 left before the oscillation start-up time reaches the above predetermined length of time, to thereby predict the time to replace the magnetrons 7. In this way, for example, when one of the magnetrons 7 has to be replaced, if time to replace another one of the magnetrons 7 is coming soon, they can be replaced at the same time, to thereby reduce the frequency of replacing the magnetrons 7, and this helps improve the user-friendliness of the microwave oven 1.

According to the present invention, the electric wave sensor 11 is provided to detect microwaves, and the time to replace a magnetron is notified when the oscillation start-up time between the application of voltage to the magnetrons 7 and the detection of the microwaves by the electric wave sensor 11 exceeds the predetermined length of time. This makes it possible to keep using the magnetrons 7 until the oscillation start-up time becomes longer due to degradation. Thus, it is possible to replace the magnetrons 7 less frequently, to thereby reduce the running cost of the microwave oven 1.

The oscillation start-up time counted in a plurality of cooking operations may be stored in the memory portion 14 in step #16, and in step #20, if the oscillation start-up time exceeds a plurality of times in a row, the process may proceed to step #21. This makes it possible to prevent replacement of the magnetrons 7 from being induced by erroneous detection of the oscillation start-up time.

Furthermore, the plurality of magnetrons 7 oscillate in different phases, and thus, it is possible for the single electric wave sensor 11 to detect whether or not oscillation has started with respect to each of the magnetrons 7, and thus, the number of components can be reduced.

Moreover, the oscillation start-up time and the cumulative driving time of the magnetrons 7 are stored in the memory portion 14, and the oscillation start-up time and the cumulative driving time are readable via the input/output portion 16, and thus, it is possible to predict how much time is left before the life of each of the magnetrons 7 comes to an end, and this helps improve the user-friendliness of the microwave oven 1.

In the present invention, the microwave oven is provided with the plurality of magnetrons 7, but a single magnetron may be provided instead. Furthermore, the electric wave sensor 11 is disposed inside the heating chamber 2, but instead, it may be disposed in the waveguide tube 8 or in the antenna chamber 9a. However, it is more desirable to dispose the electric wave sensor 11 inside the heating chamber 2, which makes it possible, in unfreezing a frozen cooking object, to judge the completion of the unfreezing based on the detection by the electric wave sensor 11.

Incidentally, although whether or not the time to replace the magnetrons 7 is judged based on the oscillation start-up time, the life and the oscillation start-up time depend on the kind of the magnetrons 7. Thus, it is preferable to set the oscillation start-up time, based on which time to replace the magnetrons 7 is determined, to a length of time that least affects a cooking operation.

### INDUSTRIAL APPLICABILITY

The present invention is applicable to a microwave oven provided with a magnetron.

### LIST OF REFERENCE SYMBOLS

1 microwave oven
2 heating chamber
3 door
4 operation panel
5 operation portion
6 display portion
7 magnetron
8 waveguide tube
9 antenna
10 antenna motor
11 electric wave sensor
12 control portion
13 power supply portion
14 memory portion
15 timer
16 input/output portion

1. A microwave oven, comprising:
a heating chamber in which a cooking object is to be placed;
a magnetron which oscillates in response to application of voltage thereto to thereby generate a microwave to be supplied into the heating chamber;
an electric wave sensor which detects the microwave generated by the magnetron;
a timer which counts oscillation start-up time of the magnetron, the oscillation start-up time starting when the voltage is applied to the magnetron and ending when the microwave generated by oscillation of the magnetron is detected by the electric wave sensor; and
a notification portion which makes a notification concerning time to replace the magnetron,
wherein
the notification portion makes the notification when the oscillation start-up time exceeds a predetermined length of time.

2. The microwave oven according to claim 1,
wherein
the oscillation start-up time is stored; and
the notification portion makes the notification if the oscillation start-up time exceeds the predetermined length of time a plurality of times in a row.

3. The microwave oven according to claim 1,
wherein
a plurality of magnetrons are provided as the magnetron; and
the magnetrons each oscillate in different phases.

4. The microwave oven according to claim 1,
wherein
the timer counts driving time of the magnetron;
the oscillation start-up time and cumulative driving time of the magnetron are stored; and
the oscillation start-up time and the cumulative driving time of the magnetron are readable.

5. The microwave oven according to claim 2,
wherein
a plurality of magnetrons are provided as the magnetron; and
the magnetrons each oscillate in different phases.

6. The microwave oven according to claim 2,
wherein
the timer counts driving time of the magnetron;
the oscillation start-up time and cumulative driving time of the magnetron are stored; and
the oscillation start-up time and the cumulative driving time of the magnetron are readable.
